(19) United States
(12) Patent Application Publication
(10) Pub. No.: US 2013/0269335 A1
(43) Pub. Date: Oct. 17, 2013

(54) Motor Having Hot Working Fluid Operating Essentially According To A Three-Phase Cycle

(71) Applicants: Pierre Lecanu, Esquay sur Seulles (FR); Jean Christophe Frydlender, Le Manoir (FR)

(72) Inventors: Pierre Lecanu, Esquay sur Seulles (FR); Jean Christophe Frydlender, Le Manoir (FR)

(73) Assignee: WIND BUILDING ENGINEERING (WIBEE), Esquay-sur-Seulles (FR)

(21) Appl. No.: 13/880,578

(22) PCT Filed: Oct. 20, 2011
(86) PCT No.: PCT/FR2011/052454

§ 371 Date: Jun. 12, 2013

(30) Foreign Application Priority Data
Oct. 22, 2010 (FR) 1058644
Dec. 21, 2010 (FR) 1060969

(51) Int. Cl. F02G 1/044

(52) U.S. Cl. CPC F02G 1/044
USPC 60/525

(57) ABSTRACT

A motor having hot working fluid having a continuously powered compression element; a constantly driving expansion element associated with at least two pairs of working chambers, each one of which comprises a cold chamber and a hot chamber connected to a hot source and isolated from the hot source by a delay system; and a linking and communication element that interacts with the compression element, the expansion element and the pairs of working chambers such that the motor continuously operates essentially according to a cycle comprising a powered compression phase, subdivided into an isothermal sub-phase and a sub-phase of raising the temperature, and a driving phase.

The aim of the present invention is to propose a motor having hot working fluid, in particular hot air, operating essentially according to a three-phase cycle.

Several different types of motors exist, operating with hot air or, more generally, with hot working gas, which, as a general rule, use four-stroke thermodynamic cycles, among which are the Carnot cycle which comprises two isothermal phases and two adiabatic phases, or the Stirling cycle which comprises two isothermal phases and two isochoric phases, or the Joule cycle which comprises two isobaric phases and two adiabatic phases, or, again, the Beau de Rochas cycle which comprises two isobaric phases and two adiabatic phases.

Of the different thermodynamic cycles, the Stirling cycle is capable of achieving a very good performance, and is therefore particularly effective.

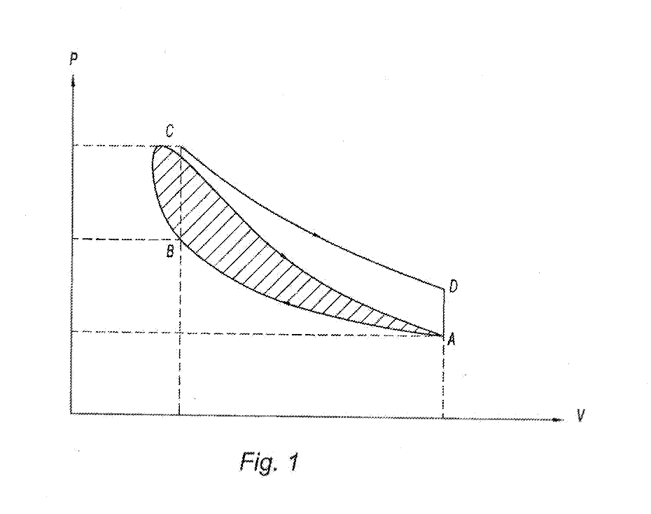

According to FIG. 1, which is a diagram representing the variations in pressure as a function of temperature, the Stirling thermodynamic cycle comprises theoretically an isothermal compression phase AB, an isochoric compression phase BC, an isothermal expansion phase CD and an isochoric expansion phase DA.

The idea behind the basis of the invention was to conceive a motor having hot working fluid using an essentially three-phase thermodynamic cycle derived from the Stirling cycle but offering an improved performance.

According to the invention, a motor of this type using hot air, whose operating cycle closely resembles a three-stroke cycle derived from the Stirling cycle, comprises essentially a powered compression phase of the working fluid, subdivided into an isothermal sub-phase and a sub-phase of raising the temperature, and a driving expansion phase of the working fluid.

A motor conforming to the invention thus comprises essentially a powered isothermal compression phase AB, a powered compression, temperature elevating phase BC and a driving expansion phase wherein the attempt is made to regulate the parameters in order it comes as close as possible to an adiabatic phase in order to increase the performance of the motor.

According to the invention, a motor of this type comprises a compression means powered constantly by some type of actuating system such as, for example, a crank-connecting rod system, and expansion means, in particular which are driven constantly.

These expansion means are associated with at least two pairs of working chambers.

Each of these pairs of chambers comprises, on the one hand, a cold chamber connected to a cold source and, on the other hand, a hot chamber connected to a hot source and isolated from said hot source by a delay system.

A means for linking and communication interacts with the compression means, the expansion means and the pairs of working chambers such that the motor continuously operates essentially according to a three-phase cycle of the type mentioned above.

According to the invention, the means for linking and communication can also advantageously comprise elements that ensure that the working fluid flows on one direction.

These means can comprise, in particular, linking tubes equipped with elements that ensure that the working fluid flows on one direction, in particular non-return valves.

The means for linking and communication can advantageously comprise transfer slide valves moving linearly and/or in rotation also.

The essential feature of the motor having hot working fluid, which is the aim of the invention, is linked to the presence of a means to delay the rise in temperature of the working fluid in the hot chambers.

This delay means in fact allows sufficient work to be obtained, illustrated diagrammatically by the cross-hatched area of the loop representing the variations in pressure as a function of temperature shown in FIG. 1.

A delay system can consist, for example, of an insulator or an insulating tube having holes limiting the exchanges of the working gas with the hot source.

It might also consist of a radiating hot source associated with a screen grid; the fresh working gas entering into the chamber is not subjected to the radiation and the temperature rises little by little.

As an alternative, the motor according to the invention can be equipped with moving hot sources or hot chambers forming a delay system.

According to the basic version of the invention, the means for compressing the working fluid consist of at least one compression piston moving to and fro constantly in a compression cylinder, such that it divides said cylinder into two compartments with variable volumes.

The means for expanding the working fluid consist, for their part, of at least two expansion pistons connected to each other, respectively associated with one of the pairs of working chambers and each moving to and fro constantly in an expansion cylinder, such that it divides said cylinder into two expansion cells with variable volumes.

According to this basic version of the invention, one of the compartments of the compression cylinder or first compartment is connected respectively by a linking tube to the hot chamber of one of the pairs of working chambers or first pair of working chambers and to the cold chamber of the other pair of working chambers or second pair of working chambers, while the other compartment of said cylinder or second compartment is connected respectively by a linking tube to the cold chamber of the first working chamber and to the hot chamber of the second working chamber.

For each of the pairs of working chambers, the unidirectional circulation elements, in particular non-return valves, allow the working fluid to flow only in opposing directions, that is, from the compression cylinder towards the hot chamber and from the cold chamber towards the compression cylinder, or from the compression cylinder towards the cold chamber or from the hot chamber towards the compression cylinder.

Each of the pairs of working chambers and each of the expansion cylinders are also associated with a transfer slide valve moving linearly and/or in rotation.

Each of these slide valves may be moved between, on the one hand, a first position or rest position in which it causes the two expansion cells of the associated expansion cylinder to communicate with each other which are then at equal pressures and isolates them from the pair of associated working chambers, and, on the other hand, a second position or driving position in which it isolates the two expansion cells of the associated expansion cylinder from each other and causes one of these cells to communicate with the hot chamber and the other cell with the cold chamber of the associated pair of working chambers.

During a first stroke in a first direction of the compression piston, the hot chamber of one of the pairs or first pair of working chambers is pressurised while the cold chamber of this same pair is depressurised and that the moving slide valve interacting with the expansion cylinder associated with this pair of working chambers is positioned in a rest position, such that the expansion cells of this expansion cylinder are at equal pressures.

For this pair of working chambers, this stroke constitutes a powered compression phase of the working fluid which corresponds to the isothermal sub-phase AB (FIG. 1) for the major part of it, and to the temperature elevation sub-phase BC for the last part of this stroke.

Simultaneously, during this same stroke, as far as the other pair or second pair of working chambers are concerned, the hot chamber of which has been compressed beforehand and the cold chamber depressurised, the associated slide valve is positioned in a driving position to isolate the two expansion cells of the expansion cylinder from each other.

This positioning of the slide valve in the driving position powers the movement of the expansion piston by the action of the pressure difference existing between the two expansion cells of the expansion cylinder.

For this pair of working chambers, this stroke constitutes the driving expansion phase CA (FIG. 1).

During the following stroke of the compression piston in the second direction opposite the first, the first pair of working chambers is now in a driving expansion phase of the working fluid while the second pair of working chambers is in a powered compression phase of this fluid and so on.

It must be noted that the powering of the compression piston requires energy but that this energy is lower, however, than that produced by the expansion.

Furthermore, it must be noted that it would be theoretically possible to have a motor according to the invention operate using hot air simply with the hot sources, i.e. dispensing with the cold chambers.

It is advantageous, moreover, according to another feature of the invention, that the volume of each of the cold chambers be larger than that of the associated hot chamber to avoid having equal pressures in the two expansion cells of the expansion cylinders at the end of the stroke of the driving phase.

The fact is that if the two expansion cells are at the same pressure, the expansion piston is no longer driven at the end of the stroke.

It must be noted, furthermore, that the volumes of the hot chambers and the cold chambers can vary so as to permit the moving masses in the motor to be modified and thus its power.

According to the invention, the expansion cells of the expansion pistons can be isolated thermally, and maintained at a predetermined temperature, or maintained at the temperature of the hot source at one of their extremities and at the temperature of the cold source at their other extremity, the purpose being to modify the parameters of the selected operating cycle.

It must be noted that, if no time-lag is provided between the expansion and compression pistons, the motor is reversible and may turn in one direction or another.

In addition, the number of expansion pistons need not be restricted but could be increased to improve the rotational stability and the performance of the motor by passing the working gas used successively from one expansion piston to another.

According to a first alternative version of the invention, the compression means and the expansion means are provided in the form of an expansion turbine and a compression turbine.

According to a second version of the invention, the compression means and the expansion means are provided in the form of the same piston.

It must be noted that although presented in the form of a motor, the motor according to the invention having hot working fluid may equally be used, like any Stirling cycle motor, for heat pumps, for refrigeration, in cogeneration, etc. . . .

The features of the hot air motor which is the aim of the invention are described in more detail with the aid of the attached non restrictive drawings in which:

FIG. 1 is a graph of P=f(V) illustrating a Stirling cycle and a three phase cycle used by the motor with hot working liquid according to the invention.

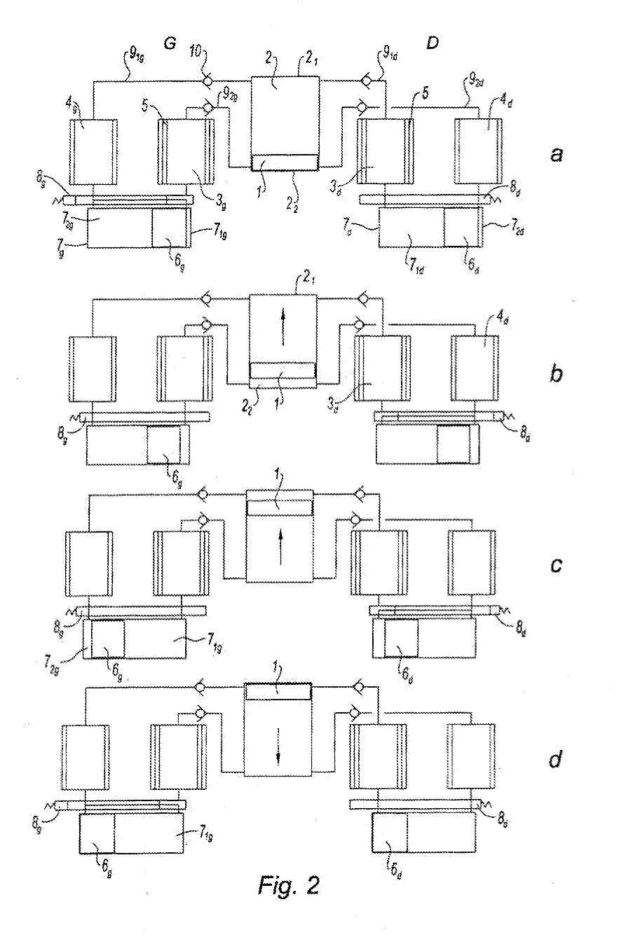

FIGS. 2a, 2b, 2c and 2d are diagrams representing the operating mode of the basic version of a motor with hot working liquid according to the invention.

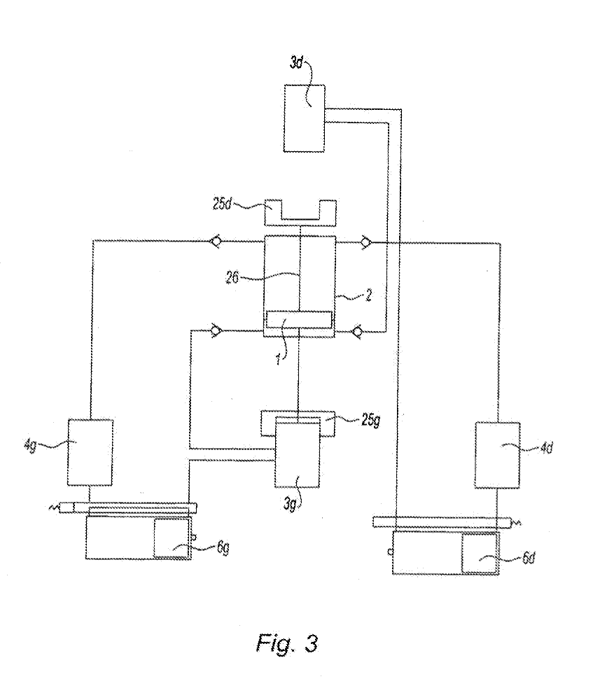

FIG. 3 is a diagram illustrating an alternative embodiment of the delay system fitted to the hot chambers of the motor with hot working liquid represented by FIGS. 2a to 2d.

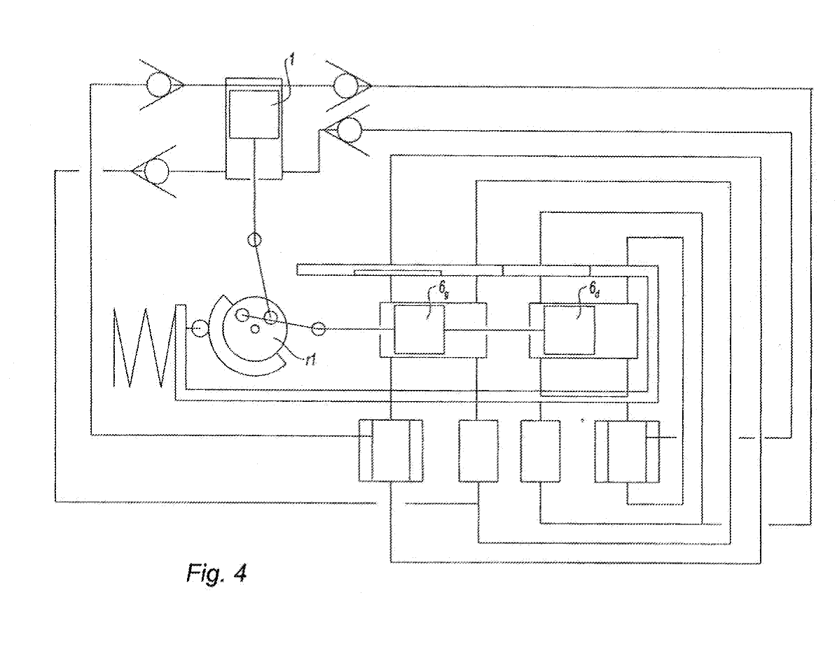

FIG. 4 is a diagram illustrating mechanical actuating elements of the compression piston and the expansion pistons of the motor with hot working liquid represented by FIGS. 2a to 2d.

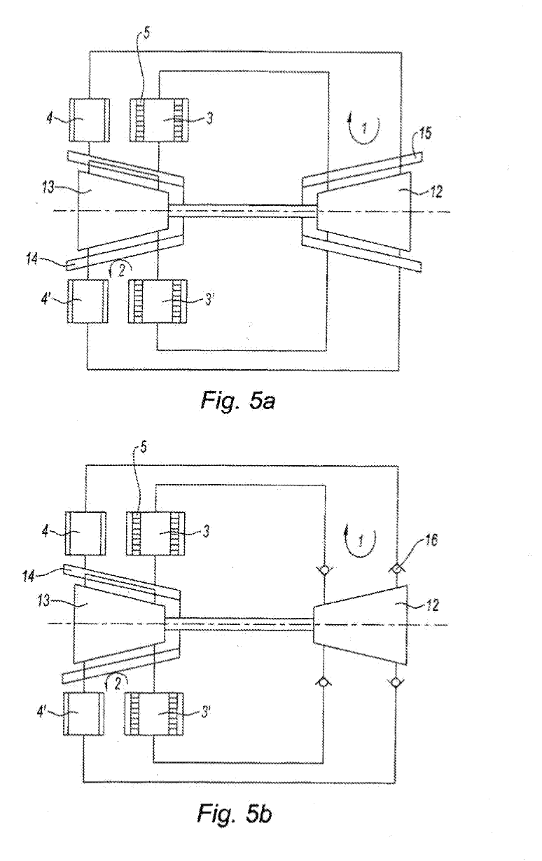

FIGS. 5a and 5b are diagrams representing the operating mode of the first version of a motor with hot working liquid according to the invention.

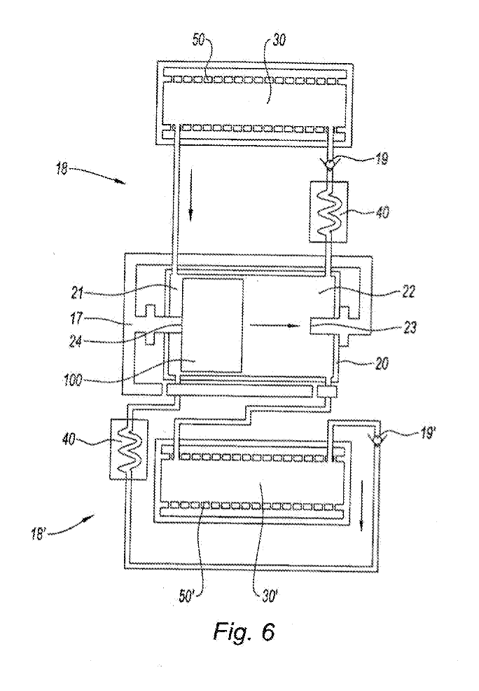

FIG. 6 is a diagram illustrating the operating mode of the second version of a motor with hot working liquid according to the invention.

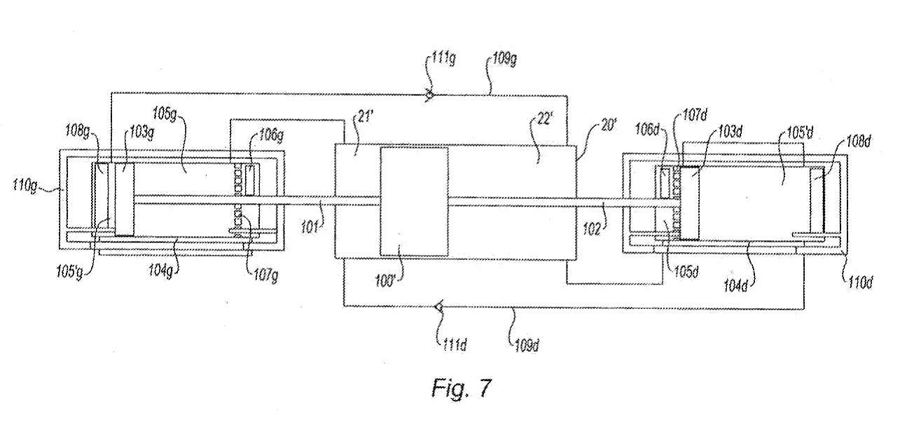

FIG. 7 is a diagram illustrating an alternative configuration of a motor with hot working liquid according the second version of the invention.

According to FIGS. 2a to 2d in the basic version, the motor with hot working liquid comprises a compression piston 1 which moves constantly to and fro in a compression cylinder 2 so that it divides said cylinder 2 into two compression compartments 2-1, 2-2 with variable volumes.

According to FIG. 4, the displacement of the compression piston 1 is controlled by a crank-connecting rod system by means of a driving motor not shown.

The motor represented in FIGS. 2a to 2d also comprises two pairs of working chambers which will be designated as right working chamber pair D and left working chamber pair G in the rest of this presentation.

These pairs of working chambers D-G each consist of a hot chamber 3d, 3g and a cold chamber 4d, 4g.

These chambers are linked respectively to a hot source and a cold source, not shown.

Also, the hot chambers 3d, 3g are isolated from the associated hot source by a delay system 5 represented diagrammatically which delays their rise in temperature.

Each of the pairs of working chambers D-G is also associated with an expansion piston 6d, 6g which moves in an expansion cylinder 7d, 7g so that is subdivides it into two expansion cells 7-1d, 7-2d, 7-1g, 7-2g.

According to FIG. 3, the two expansion pistons 6d and 6g are linked to each other so that they move in tandem and are linked also to the crank-connecting rod system 11.

The motor with hot working fluid represented in the FIGS. 2a to 2d also comprises two communication slide valves 8d, 8g which are associated respectively with each of the pairs of working chambers D-G and with each of the expansion cylinders 7d, 7g.

These communication slide valves 8d, 8g can move between a rest position represented by the left hand part of FIG. 2a and a driving position represented by the right hand part of FIG. 2a.

In the rest position, these two expansion cells 7-1g and 7-2g of the expansion cylinder 7g communicate with each other such that their pressures are equal and they are isolated from the chambers 3g, 4g of the associated pair of working chambers G.

In the driving position, the two expansion cells 7-1d and 7-2d of the expansion cylinder 7d are isolated from each other, and the cell 7-1d communicates with the hot chamber 3d while the cell 7-2d communicates with the cold chamber 4d of the associated pair of working chambers D.

Furthermore, and according to FIGS. 2a to 2d, each of these compartments 2-1, 2-2 of the compression cylinder 2 is linked respectively by the linking tubes 9-1d, 9-1g and 9-2d, 9-2g to the chambers 3d, 4g; 4d, 3g of the pairs of working chambers D-G.

The linking tube 9-1d links the compartment 2-1 to the hot chamber 3d and the linking tube 9-1g links the compartment 2-1 to the cold chamber 4g while the linking tube 9-2d links the compartment 2-2 to the cold chamber 4d and the linking tube 9-2g links the compartment 2-2 to the cold chamber 3g.

These linking tubes 9-1d, 9-1g, 9-2d, 9-2g are equipped respectively with non-return valves 10 which allow the working fluid in these cells to flow only in one direction.

More specifically, the working fluid can flow only from the compartment 2-1 towards the hot chamber 3d and from the cold chamber 4g towards this compartment or from the compartment 2-2 towards the hot chamber 3g and from the cold chamber 4d towards this compartment.

According to FIG. 2a, the compression piston 1 is represented at the end of the descending stroke and the pair of working chambers D and the expansion piston 6d are represented at the end of the expansion phase while the pair of working chambers G and the expansion piston 6g are represented at the end of the compression phase; the hot chamber 3g has thus been heated beforehand and pressurised.

According to FIG. 2b, at the end of the subsequent ascending stroke of the compression piston 1 indicated by the arrow, the communication slide valve 8d is moved to the rest position and the communication slide valve 8g is moved to the driving position.

The hot chamber 3d is thus pressurised while the expansion piston 6g is moved to the left as shown diagrammatically by the arrow, and powering the expansion piston 6d as a result of the pressure difference existing between the expansion cells 7-1g, 7-2g of the expansion cylinder 7g.

The pair of hot working chambers D and the expansion piston 6d are then in the isothermal sub-phase of the powered compression phase, while the pair of working chambers G and the expansion piston 6g are in the driving expansion phase.

According to FIG. 2c, at the end of the ascending stroke of the compression piston 1, the position of the communication slide valves 8g, 8d is unchanged, and the expansion piston 6g moves towards the left in the expansion phase.

The temperature of the compressed working fluid present in the hot chamber 3d is then increased by the associated hot source, such that the pair of working chambers D and the expansion piston 6d are in the temperature elevation sub-phase of the driving compression phase.

According to FIG. 2d, at the start of the subsequent descending stroke of the compression piston 1 indicated by the arrow, the communication slide valve 8d is moved from the rest position and the communication slide valve 8g is moved to the driving position.

The expansion piston 6g and the pair of working chambers G are thus in the isothermal sub-phase of the powered compression phase and the expansion piston 6d and the working chambers D are at the start of the expansion phase.

It follows from the above that that, during all of the movement to and fro of the compression piston 1, one of the expansion pistons 6d, 6g is always in a driving expansion phase.

Then, and as indicated earlier, the actuating energy of the compression piston 1, which pressurises the hot chambers 3d, 3g, is lower than the energy produced by the expansion.

It must be noted that it would be possible, by modifying the trajectory of the linking tubes, that the working fluid would circulate, during a first cycle, for example, towards the right expansion piston, then, during the subsequent cycle, towards the left expansion piston and so on without changing either the functioning principle or the performance of the system.

According to FIG. 3 which corresponds to FIG. 2a, the motor is fitted with two moving hot sources 25d, 25g, respectively associated with a hot chamber 3d, 3g and mounted permanently on the rod 26 of the compression piston 1 on either side of this piston.

The hot chambers 3d, 3g are mounted in relation to the associated hot source 25d, 25g.

As a result, when the compression piston 1 moves in the compression cylinder 2, these hot sources 25d, 25g approach or move away in the associated hot chamber 3d, 3g and thus constitute a delay system capable of delaying the rise in temperature of this hot chamber during the powered compression phase.

According to FIGS. 5a and 5b, the compression piston 1 is replaced by a compression turbine 12 and the two expansion pistons 6d, 6g are replaced by an expansion turbine 13.

The two turbines 12, 13 are linked solidly.

A rotary transfer slide valve 14 allows the expansion turbine 13 to communicate with the pair of hot and cold working chambers 3, 4 or with the pair of hot and cold working chambers 3′, 4′.

According to FIG. 5a, a second rotary transfer slide valve 15 allows the compression turbine 12 to communicate with the pair of hot and cold working chambers 3′, 4′ or with the pair of hot and cold working chambers 3, 4.

According to FIG. 5b, this second rotary transfer slide valve 15 is replaced by non-return valves 16.

According to the upper part of FIGS. 5a and 5b, the pair of hot 3 and cold 4 chambers is represented in the powered compression phase, i.e. that the compression turbine 12 is forcing the working fluid into the cold chamber 4 to compress it towards the hot chamber as shown diagrammatically by the arrow 1.

The temperature of the working fluid thus compressed in the hot chamber 3 rises progressively at the end of this driving phase owing to the presence of the delay system 5.

Simultaneously, the pair of hot 3′ and cold 4′ chambers represented in the lower part of these figures is in the driving expansion phase, i.e. that the expansion turbine 13 is controlling the expansion of the working fluid, previously compressed in the hot chamber 3′, towards the cold chamber 4′ as shown diagrammatically by the arrow 2.

At the end of this double process, the rotary slide valve 14 and, as the case may be, the rotary slide valve 5 [sic] is/are moved such that the pair of hot 3′ and cold 4′ chambers located in the lower part are in the powered compression phase, whereas, on the contrary, the pair of hot 3 and cold 4 chambers located in the upper part are in the driving expansion phase.

This movement of the rotary transfer slide valve(s) is happening constantly.

It is essential, according to this first alternative version of the invention, that one of the pairs of working chambers 3, 4 or 3′, 4′ is always in the driving expansion phase.

It must be noted that a motor with hot working fluid of this type, comprising a compression turbine and an expansion turbine could operate as a result of differences in pressure and could be equipped with control valves linking the hot chamber and the cold chamber of each of the pairs of working chambers to the expansion turbine and to the compression turbine.

A motor of this type could operate, therefore, by automated control, for example, a PLC.

According to FIG. 6, the compression piston 1 as well as the two expansion pistons 6b [sic], 6g are replaced by a single piston 100 moving in a cylinder 20 such that it subdivides this cylinder into two compartments 21, 22.

A linear slide valve 17 allows each of these two compartments 21, 22 to connect at their extremities with a linking circuit 18, 18′.

These two linking circuits 18, 18′ are represented respectively in the upper part and the lower part of FIG. 6.

A hot chamber 30, 30′ linked to a hot source, not shown, and equipped with a delay system 50, 50′, and a cold chamber 40, 40′ linked to a cold source, not shown, as well as a non-return valve 19, 19′, are mounted in series on each of the linking circuits 18, 18′.

To be more precise, the compartment 21 is linked directly to the upper hot chamber 30 and the lower cold chamber 40′, while the compartment 22 is linked directly to the upper cold chamber 40 and the lower hot chamber 30′.

The non-return valves 19, 19′ are mounted so that they only allow the flow of working fluid from the cold source 40, 40′ towards the hot source 30, 30′ in the direction indicated by the arrows.

According to FIG. 6, the cylinder 20 is shown to be connected via the upper linking circuit 18 and isolated from the lower linking circuit 18′.

In this position, the hot working fluid, previously compressed in the hot chamber 30 expands, entering the compartment 21, and pushes the piston 100, as shown diagrammatically by the arrow.

At the same time, the working fluid present in the compartment 22 is compressed and transferred to the hot chamber 30 in which it then rises in temperature due to the presence of the delay system 50.

This movement of the piston 100 continues until it has reached the stop 23, which causes a linear movement of the slide valve 17 and communication between the cylinder 20 and the lower linking circuit 18′.

The expansion and compression phases of the working fluid are produced, therefore, in a similar fashion in this circuit until the piston 100 has reached the stop 24 and is situated in the position represented by FIG. 5, and so on.

According to FIG. 7, a single piston 100′, comprising an expansion piston and a compression piston at the same time, is also moving in a cylinder 20′ such that it subdivides this cylinder into two compartments 21′, 22′.

This piston 100′ is linked solidly by means of rods 101, 102 extending respectively at each end of the former to two filling pistons 103d, 103g moving linearly to and fro in a filling cylinder 104g, 104d such that they subdivide this cylinder into two respective compartments 105g, 105′g, 105d, 105′d.

One of these chambers 105g, 105d is equipped at its extremity with a hot source 106g, 106d interacting with a delay system 107g, 107d and thus constituting a hot chamber while the other chamber 105′g, 105′d is equipped with a cold source 108g, 108d and thus constituting a cold chamber.

Compared with the configuration represented in FIG. 6, this configuration thus presents the advantage of allowing the hot and cold sources to be separated respectively.

According to FIG. 7, the two compartments of the cylinder 20′ are connected via a linking circuit 109g on which the filling cylinder 104g is mounted and via a linking circuit 109d on which the filling cylinder 104d is mounted.

A linear slide valve 110g allows the direct linking of the compartment 21′ with the hot chamber 105g and the compartment 22′ with the cold chamber 105′d, while a linear slide valve 110d allows the direct linking of the compartment 21′ with the cold chamber 105′d and the compartment 22′ with the hot chamber 105d.

Non-return valves 111g, 111d are mounted on the linking circuits 109g, 109d such that they allow the working fluid to flow in one direction only.

The operating mode of the motor according to this alternative corresponds to that of the motor according to the second version of the invention represented in FIG. 6.

### TERMINOLOGY

1 Compression piston
2 Compression cylinder
2-1; 2-2 Compression compartments
3, 3′ Hot chambers
3d, 3g Hot chambers
4, 4′ Cold chambers
4d, 4g Cold chambers
5 Delay system
6d, 6g Expansion piston
7d, 7g Expansion cylinders
7-1d, 7-1g Expansion cells
7-2d, 7-2g Expansion cells
8d, 8g Communication slide valves
9-1d, 9-1g Linking tubes
9-2d, 9-2g Linking tubes
10 Non-return valves
11 Crank-connecting rod system
12 Compression turbine
13 Expansion turbine
14 Rotary transfer slide valve
15 Rotary transfer slide valve
16 Non-return valves
17 Linear slide valve
18 Linking circuits
19, 19′ Non-return valves
20, 20′ Cylinder
21, 21′ Compartment
22, 22′ Compartment
23 Stop
24 Stop
25d, 25g Hot sources
26 Piston rod
30, 30′ Hot chambers
40, 40′ Cold chambers
50, 50′ Delay system
100, 100′ Piston
101, 102 Rods
103g, 103d Filling pistons
104g, 104d Filling cylinders
105g, 105d Hot chambers
105′g, 105′d Cold chambers
106g, 106d Hot sources
107g, 107d Delay systems
108g, 108d Hot sources
109g, 109d Linking circuits
110g, 110d Moving slide valves
111g, 111d Non-return valves

1. Motor having hot working fluid characterised in that it comprises:
a compression means of the working fluid powered constantly by some type of actuating system,
a constantly driving expansion means of the working fluid and associated with at least two pairs of working chambers, each one of which comprises, on the one hand, a cold chamber connected to a cold source and, on the other hand, a hot chamber connected to a hot source and isolated from said hot source by a delay system, and
a means of linking and communication that interacts with the compression means, the expansion means and the pairs of working chambers such that the motor continuously operates essentially according to a three-phase cycle derived from the Stirling cycle and comprising a powered compression phase of the working fluid, subdivided into an isothermal sub-phase and a sub-phase of raising the temperature, and a driving expansion phase of the working fluid.

2. Motor according to claim 1, characterised in that the means for linking and communication comprise elements that ensure that the working fluid flows on one direction

3. Motor according to claim 2, characterised in that the means for linking and communication comprise linking tubes equipped with elements that ensure that the working fluid flows on one direction, in particular non-return valves.

4. Motor according to claim 1, characterised in that the means for linking and communication comprise transfer slide valves moving linearly and/or in rotation.

5. Motor according Any to claim 1, characterised in that
the means for compressing the working fluid consist of at least one compression piston moving to and fro constantly in a compression cylinder, such that it divides said cylinder into two compartments with variable volumes, and
the means for expanding the working fluid consist of at least two expansion pistons connected to each other, respectively associated with one of the pairs of working chambers and each moving to and fro constantly in an expansion cylinder, such that it divides said cylinder into two expansion cells with variable volumes.

6. Motor according to claim 3, characterised in that
one of the compartments of the compression cylinder or first compartment is connected respectively by a linking tube to the hot chamber of one of the pairs of working chambers or first pair of working chambers and to the cold chamber of the other pair of working chambers or second pair of working chambers, while the other compartment of said cylinder or second compartment is connected respectively by a linking tube to the cold chamber of the first working chamber and to the hot chamber of the second working chamber, and
for each of the pairs of working chambers, the unidirectional circulation elements, in particular non-return valves, allow the working fluid to flow only in opposing directions, that is, from the compression cylinder towards the hot chamber and from the cold chamber towards the compression cylinder, or from the compression cylinder towards the cold chamber or from the hot chamber towards the compression cylinder

7. Motor according to claim 6, characterised in that each of the pairs of working chambers and each of the expansion cylinders are also associated with a transfer slide valve moving linearly and/or in rotation, each of these slide valves may be moved between, on the one hand, a first position or rest position in which it causes the two expansion cells of the associated expansion cylinder to communicate with each other and isolates them from the pair of associated working chambers, and, on the other hand, a second position or driving position in which it isolates the two expansion cells of the associated expansion cylinder from each other and causes one of these cells to communicate with the hot chamber and the other cell with the cold chamber of the associated pair of working chambers, and
in response to the actuation of the compression piston, the hot chamber of one of the pairs or first pair of working chambers is pressurised while the cold chamber of this same pair is depressurised and that the moving slide valve interacting with the expansion cylinder associated with this pair of working chambers is moved to a rest position, and, simultaneously, the moving slide valve associated with the other pair of working chambers is positioned in a driving position, such that the two expansion pistons are always driven.

8. Motor according to claim 1, characterised in that the volume of each of the cold chambers is larger than that of the associated hot chamber.

9. Motor according to claim 1, characterised in that the compression means and the expansion means are provided in the form of an expansion turbine and a compression turbine.

10. Motor according to claim 1, characterised in that the compression means and the expansion means are provided in the form of the same piston.

11. Motor according to claim 5, characterised in that one of the compartments of the compression cylinder or first compartment is connected respectively by a linking tube to the hot chamber of one of the pairs of working chambers or first pair of working chambers and to the cold chamber of the other pair of working chambers or second pair of working chambers, while the other compartment of said cylinder or second compartment is connected respectively by a linking tube to the cold chamber of the first working chamber and to the hot chamber of the second working chamber, and
for each of the pairs of working chambers, the unidirectional circulation elements, in particular non-return valves, allow the working fluid to flow only in opposing directions, that is, from the compression cylinder towards the hot chamber and from the cold chamber towards the compression cylinder, or from the compression cylinder towards the cold chamber or from the hot chamber towards the compression cylinder.

12. Motor according to claim 11, characterised in that each of the pairs of working chambers and each of the expansion cylinders are also associated with a transfer slide valve moving linearly and/or in rotation, each of these slide valves may be moved between, on the one hand, a first position or rest position in which it causes the two expansion cells of the associated expansion cylinder to communicate with each other and isolates them from the pair of associated working chambers, and, on the other hand, a second position or driving position in which it isolates the two expansion cells of the associated expansion cylinder from each other and causes one of these cells to communicate with the hot chamber and the other cell with the cold chamber of the associated pair of working chambers, and
in response to the actuation of the compression piston, the hot chamber of one of the pairs or first pair of working chambers is pressurised while the cold chamber of this same pair is depressurised and that the moving slide valve interacting with the expansion cylinder associated with this pair of working chambers is moved to a rest position, and, simultaneously, the moving slide valve associated with the other pair of working chambers is positioned in a driving position, such that the two expansion pistons are always driven.

13. Motor according to claim 4, characterised in that each of the pairs of working chambers and each of the expansion cylinders are also associated with a transfer slide valve moving linearly and/or in rotation, each of these slide valves may be moved between, on the one hand, a first position or rest position in which it causes the two expansion cells of the associated expansion cylinder to communicate with each other and isolates them from the pair of associated working chambers, and, on the other hand, a second position or driving position in which it isolates the two expansion cells of the associated expansion cylinder from each other and causes one of these cells to communicate with the hot chamber and the other cell with the cold chamber of the associated pair of working chambers, and in response to the actuation of the compression piston, the hot chamber of one of the pairs or first pair of working chambers is pressurised while the cold chamber of this same pair is depressurised and that the moving slide valve interacting with the expansion cylinder associated with this pair of working chambers is moved to a rest position, and, simultaneously, the moving slide valve associated with the other pair of working chambers is positioned in a driving position, such that the two expansion pistons are always driven.
